(19) United States
(12) Patent Application Publication
(10) Pub. No.: US 2006/0017841 A1
(43) Pub. Date: Jan. 26, 2006

(54) Surveillance Camera Mount for Pegboard

(76) Inventor: Brian Joseph Farrell, Clark, NJ (US)

Correspondence Address: Brian Farrell, 6 Ginesi Dr., Clark, NJ, 07066, US

(21) Appl. No.: 11/161,129

(22) Filed: Jul. 25, 2005

Related U.S. Application Data
(60) Provisional application No. 60/591,175, filed on Jul. 26, 2004.

(51) Int. Cl. H04N 5/225

(52) U.S. Cl. 348/373

(57) ABSTRACT

A small, unobtrusive surveillance camera mount consisting of a body (10) with integral peg hooks (12) which allows for fast, easy, primarily concealed means of attaching to pegboard (34). The camera mount features a set of stanchions (22) and a hole for board camera lens (36) that allow for the mounting of a board style video camera (30) in a way that facilitates a pinhole lens to directly align with one of the holes in the pegboard so as to be able to capture surveillance footage of persons or items on the opposite side of the pegboard in a primarily covert manner.

### CROSS-REFERENCE TO RELATED APPLICATIONS

This patent application relates to my previously filed provisional patent application. That provisional application was filed by me, Brian Joseph Farrell, Clark, N.J.; assigned application No. 60/591,175 with a filing date of Jul. 26, 2004, bearing the title Surveillance camera mount for pegboard.

### FEDERALLY SPONSORED REASEARCH

Not Applicable

### SEQUENCE LISTING OR PROGRAM

Not Applicable

### BACKGROUND OF THE INVENTION

1. Field of Invention

This invention relates to surveillance cameras mounts, commonly referred to as surveillance, security, CCTV, video, covert, and others, specifically to such applications were the camera is attached to pegboard.

2. Background of the Invention

Retail stores, department stores, warehouse style stores, grocery stores, supermarkets, offices, businesses, warehouses, homes, and many other places have needs to conduct surveillance activities to assist in fighting theft and fraud, protecting the safety and security of individuals, and providing a general well-being to the premises. Typically, a person wishing to conduct such surveillance is required to have a strong working knowledge of traditional video surveillance, or CCTV equipment in order to achieve a good result. Even persons of knowledge regarding such equipment are typically limited by the ways and manner in which traditional surveillance equipment may be deployed.

When a particular need arises to capture surveillance footage in an unobtrusive or covert manner, the equipment and applications for such uses are rather limited. These limitations are resultant from the fact that traditional equipment is typically expensive, complicated, difficult to set up, and offer limited means and ways in which the equipment may be deployed.

Retail stores, department stores, warehouse style stores, grocery stores, supermarkets, offices, businesses, warehouses, homes, and many other places use pegboard in a wide variety of applications. Such pegboard applications include the display of merchandise, the display of signage, the storage and display of items, shelf backing, and many more. Inventors have created several types of surveillance cameras and camera mounts in an attempt to address the needs of entities previously mentioned. These surveillance cameras are inclusive of both overt and covert applications.

Many of these inventions rely on discreetly concealing a surveillance camera within another object such as a clock or smoke detector such as it is found in U.S. Pat. No. 6,249,310 to Lefkowitz (2001), or such as in a sprinkler head in U.S. Pat. No. 4,963,962 to Kruegle, et al. (1990). However, these types of camera concealments offer a very limited range of applications. Typically they must be located within an area where as the overt item may easily be placed and would not arouse suspicion, not necessarily were the camera would be best used.

Other types of surveillance camera mounts such as is found in U.S. Pat. No. 6,912,007 to Gin (2005) although being an enclosed mount being capable of utilizing a smaller then traditional size camera, rely on merely being less obtrusive, or less prone to access than some more traditional surveillance cameras, but completely lack any sort of reliance on being covert, easily deployed, or flexible in their applications.

Additional inventions such as is found in U.S. Pat. No. 5,990,938 to Bern (1999) although potentially implementing elements of covert surveillance capabilities and being described as a portable showcase security system, really appears to be limited in its abilities and not easily portable.

All of the above-mentioned types of enclosures and systems suffer from a number of disadvantages: they are not easily installed, nor easily removed, tend to leave damage or evidence of use one removed, have a limited range of field of view, require complicated installations and hardware, require the user to have a solid working knowledge of the device and CCTV systems in general, and may be very costly. I was unable to locate a single surveillance camera application that specifically addressed the ability to be mounted to, or take advantage of a pegboard mounting use.

Many persons have used what is commonly known as a pinhole lens in attempts to acquire covert surveillance footage. This type of application allows the main body of the camera to remain primarily concealed while only exposing a small portion of the lens to the area that is subject to the surveillance. Pinhole lens may be applied to surveillance cameras of all sizes, including the small size board camera. These applications suffer the same disadvantages as mentioned above and are additionally subject to potential abuses and other unfavorable factors.

Many other inventors have been issued patents whereas their invention relates to the use of pegboard primarily for retail and storage applications. U.S. Pat. No. 5,746,328 to Beeler (1998) discloses a pegboard mount merchandise rack whereas although it shows a general pegboard application for displaying retail items, there is no direct correlation to any surveillance applications. A similar U.S. Pat. No. 6,702,128 to Winig, et al. also depicts a pegboard mounted display, but fails to show any further application such as mounting a surveillance camera.

### OBJECTS AND ADVANTAGES

My invention takes advantage of the fact that there is a tremendous need for the gathering of surveillance footage in combination with the fact that pegboard is a common material in use in many places. Additionally, my invention is exceptionally well suited at gathering covert surveillance footage in ways and with an ease that simply cannot be achieved by the use of any other surveillance equipment.

Accordingly, I have determined there to be several objects and advantages of the present invention which are:
(a) to provide a surveillance camera mount that is very easily deployed as it can be utilized anywhere there is pegboard;
(b) to provide a surveillance camera mount that is deployable in a manner that allows the main body of the mount to remain concealed, thereby providing covert surveillance capabilities;
(c) to provide a surveillance camera mount that can be very easily deployed as it requires no tools or hardware to set up;
(d) to provide a surveillance camera mount that can be very easily and very quickly located or relocated to an area of the users choosing;
(e) to provide a surveillance camera mount that can be used in a covert or not obtrusive manner where traditional cameras and mounts would be impractical or ineffective;
(f) to provide a surveillance camera mount that does not require any special electrical power specifications;
(g) to provide a surveillance camera mount which can be easily produced in a variety of sizes, colors, textures, and shapes so as to provide the greatest covert tactical advantages;
(h) to provide a surveillance camera mount which can be produced in economical manner;
(i) to provide a surveillance camera mount that, while remaining covert, would yield surveillance footage at close ranges that are typically not achievable with traditional equipment;
(j) to provide a surveillance camera mount that, while remaining covert, would yield surveillance footage with angles and fields of view that are typically not achievable with traditional equipment.

Further objects and advantages are to provide a surveillance camera mount that can be used easily and conveniently by persons with a minimal or no working knowledge of traditional surveillance systems, thereby making it possible for the average person to utilize effectively. Still further objects and advantages will become apparent from a consideration of the ensuing description and drawings.

### SUMMARY

In accordance with the present invention a surveillance camera mount for pegboard comprises a hollow body featuring integral pegboard hooks, a precisely placed hole and stanchions for aligning the surveillance camera lens directly in line with one peg hole, a removable rear cover, and a port where to route wires.

### DRAWINGS—FIGURES

FIG. 1 shows a surveillance camera mount for pegboard, from an angle of the top right rear, with the rear cover removed, with a board style surveillance camera mounted in the main body, as it would align with the pegboard.

FIG. 2 shows a surveillance camera mount for pegboard from a front view.

FIG. 3 shows a surveillance camera mount for pegboard from a side view.

FIG. 4 shows a surveillance camera mount for pegboard from a rear view.

FIG. 5 shows a surveillance camera mount for pegboard from a bottom view.

### DRAWINGS—REFERENCE NUMERALS

10 body
14 recessed shelf
18 hole for cord
22 stanchions
26 top slot and tab
30 board camera
34 pegboard
12 integral peg hooks
16 bottom slot and tab
20 shelf for cord strain relief
24 rear cover
28 screwdriver slot
32 board camera mounting screws
36 hole for camera lens

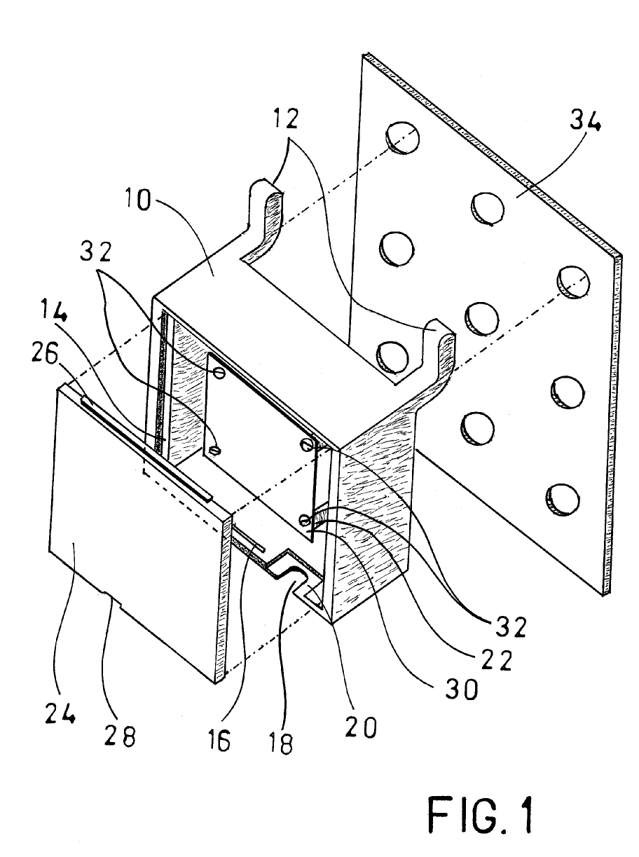

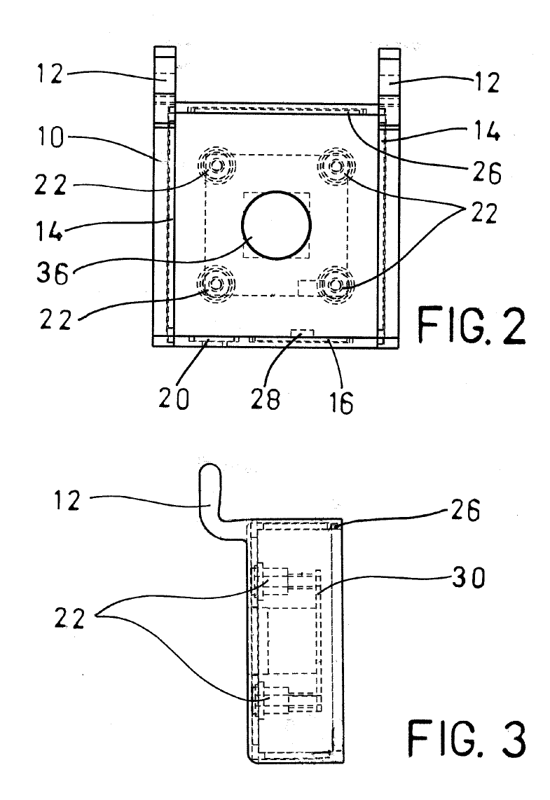

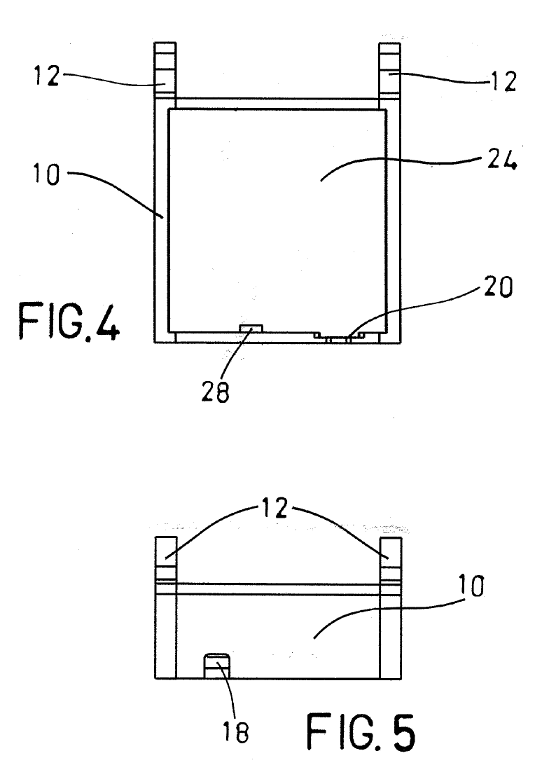

### DETAILED DESCRIPTION—FIGS. 1-5—PREFERRED EMBODIMENT

A preferred embodiment of the camera mount of the present invention is illustrated in each of the FIGS. 1 through 5.

The camera mount has a body 10 comprised of a moderately rigid material, which can withstand the rigors of service, while providing just enough flexibility to be able to bend slightly with adequate pressure to facilitate attaching and detaching the rear cover 24. Additionally, the material must allow enough strength so as to be able to support the entirety of the weight of the assembly as it is suspended mechanically and gravitationally by the integral peg hooks 12. In the preferred embodiment, the base and the rear cover are made of plastic. However, either of these components can consist of any other material that can be flexed, milled, machined or attached by other means, without breaking, fracturing or significant distortion, such as metal, wood, resin, various impregnated or laminated fibrous materials, etc.

The surveillance camera mount is assembled by attaching the board camera 30 to the stanchions 22 and securing with board mounting screws 32 in a manner that provides for an eventual direct alignment of the lens through the hole for camera lens 36 with one of the holes in the pegboard. The rear cover 24 is then attached to the body 10 by aligning and inserting the top tab 26 to its corresponding slot, then rotating it down into position where the edges rest on the recessed shelf 14, and the bottom tab snaps into place in the bottom slot 1 6, where the rear cover 24 lies flush with the rest of the rear portion of the body 10. During assembly the lead wires and cords of the board camera 30 are routed through the hole for cord 1 8. The cord strain relief device is fitted to the shelf for cord strain relief 20 and retained in place by the rear cover 24. Note that the lead wires and cords of the board camera have been omitted from these figures to prevent unnecessary clutter, as they are not immediately necessary in demonstrating the purpose and function of the invention.

This preferred embodiment utilizes a very small lens that typically measures approximately 2 to 4 mm across and is commonly referred to as a pinhole lens on the board camera 30. The use of such a pinhole lens as would be employed in the aforementioned description would allow the user to easily and consistently align the said lens with the pegboard hole. The combination of the pinhole lens in alignment with the pegboard hole allows for the camera to see through the pegboard hole and capture surveillance footage of what is on the opposite side of the pegboard from the body 10. Thereby unobtrusive, covert surveillance is obtained of those scenes on the opposite side of the pegboard 34. Typically all that would be easily visible from the opposite side of the pegboard 34 would be a small portion of the integral peg hooks 12.

There is also a screwdriver slot 28 formed into the rear cover 24 to help aid and assist in the installation and removal of the rear cover 24.

The integral peg hooks 12 are of such a size and design to prevent damaging the pegboard during installation, while providing a snug and stable fit once in place.

Operation

Once the user of the camera mount has attached the board camera 30 of their choosing and secured the rear cover 24 the body 10 is then maneuvered in such a way where it is held approximately perpendicular, or 90°, to the pegboard 34 and the tops of the integral peg hooks 12 align with peg holes. At this point the top of the body 10 would be seen as directly facing and perpendicular to the pegboard 34. The integral peg hooks 12 are inserted into the pegboard 34 as the body 10 is rotated down, approximately 90°, to where it is eventually fully inserted and rests flush against the pegboard 34. The integral peg hooks 12 are of such a shape and design that the normal gravitational forces bearing down upon the entirety of the body 10 allows for a snug, flush fit with no further need for fastening.

After the surveillance camera mount for pegboard is installed, the user would then apply and connect the appropriate power and video feed cord(s). The rest of the specificities of operation would depend upon the users specific application and any other surveillance equipment.

To remove the surveillance camera mount for pegboard the user would simply disconnect any power and video feed cords, then reverse the above directions. Specifically, the body 10 would be pivoted upward as the integral peg hooks 12 rotated to a position where the body 10 was approximately 90° from its starting position and pulled in a direction straight away from the pegboard 34.

Advantages

From the description above, a number of advantages of my surveillance camera mount for pegboard become evident:
(a) The invention allows for the easy and convenient use of covert surveillance equipment.
(b) The invention will help provide inexperienced persons with the capability of easily deploying covert surveillance equipment.
(c) There are no tools or hardware required for the actual mounting of the surveillance camera mount to the pegboard.
(d) The invention can be used in a very wide variety of areas, typically much more than traditional surveillance equipment allows.
(e) The invention can be produced easily and any cost-effective manner.
(f) The invention can be used anywhere that pegboard is present.
(g) There are many additional advantages that would become evident to the user.
   Conclusion, Ramifications, and Scope

Accordingly, the reader will see that the surveillance camera mount for pegboard of this invention can be deployed for use easily anywhere pegboard is present, can be removed and redeployed just as easily without damaging the pegboard and without the need for mounting hardware or tools or any special knowledge of surveillance equipment. In addition, my invention allows for the collection of surveillance footage, including covert surveillance footage, which would otherwise be impractical or impossible to obtain with more traditional surveillance equipment. Furthermore, my invention has the additional advantages of being easy and economical to produce in a variety of materials, colors, sizes, and textures whereas these features create a significant advantage in being adaptable to the needs of the user especially where the surveillance is of a covert nature.

Although the description above contains many specificities, these should not be construed as limiting the scope of the invention but as merely providing illustrations of the presently preferred embodiments of this invention. I have described herein one of many possible embodiments while maintaining the spirit of my invention. For example, some of the possible embodiments are:
using the body assembly with or without the rear cover or permanently affixing the rear cover;
forming the body assembly in a variety of shapes and sizes or with or without one or more of the sides or top or bottom;
utilizing different mechanisms to fasten the rear cover to the body, such as with magnets, clasps, hasps, clips, locking mechanisms, pins, latches, bolts, screws, nuts, nails, hook and loop, eyes, snaps and buttons;
adding or reducing the number of integral pegs;
adding additional features or specifications to the video surveillance components, such as high-resolution, low light, CCD, CMOS, infrared, wireless capabilities etc.;
modifying the form and size of components to allow for use of any type of image capturing device;
adding additional features or hardware that would serve to make the body more difficult or impossible to remove from pegboard by unauthorized persons.

What is claimed is:

1. A surveillance camera mount of the type comprising a main body with peg hooks that provides the ability to mount onto pegboard.

2. The surveillance camera mount of claim 1 wherein said body is composed of plastic.

3. The surveillance camera mount of claim 1 wherein said body features stanchions to which a surveillance camera is mounted.

4. The surveillance camera mount of claim 1 wherein said body features a camera lens hole.

5. A surveillance camera mount of the type comprising a main body with peg hooks that provides the ability to mount onto pegboard, featuring integral stanchions and camera lens hole that work in conjunction to align a mounted surveillance camera directly in line with a pegboard hole.

6. The surveillance camera mount of claim 5 wherein said body and stanchions accepts a board style surveillance camera.

7. The surveillance camera mount of claim 5 wherein said body and stanchions accepts a pinhole style lens equipped surveillance camera.

8. A surveillance camera mount of the type comprising a main body with peg hooks that provides the ability to mount onto pegboard, featuring a method for aligning a pinhole lens equipped surveillance camera directly in line with a pegboard hole.

9. The surveillance camera mount of claim 8 for the specific purpose of allowing collection of surveillance footage through the pegboard hole to the opposite side of the pegboard.

10. The surveillance camera mount of claim 8 wherein the body of the mount remains behind the opposite side of the pegboard as to where the surveillance target is located, resulting in the body of the surveillance camera mount to remain out of view of persons located on the surveillance target side of the pegboard.

11. A surveillance camera mount of the type comprising a main body with peg hooks that provide the ability to attach to pegboard without the need or use of any tool or hardware.
